(19) United States
(12) Patent Application Publication
(10) Pub. No.: US 2022/0021987 A1
(43) Pub. Date: Jan. 20, 2022

(54) METHOD, HEARING SYSTEM AND COMPUTER READABLE MEDIUM FOR IDENTIFYING AN INTERFERENCE EFFECT

(71) Applicant: SIVANTOS PTE. LTD., SINGAPORE (SG)

(72) Inventor: FRANK BECK, SPARDORF (DE)

(21) Appl. No.: 17/369,023

(22) Filed: Jul. 7, 2021

(30) Foreign Application Priority Data
Jul. 20, 2020 (DE) 10 2020 209 048.3

(51) Int. Cl. H04R 25/00; G10L 21/0208; G10L 25/30; G06N 3/08

(52) U.S. Cl. CPC H04R 25/507; G06N 3/08; G10L 25/30; G10L 21/0208

(57) ABSTRACT

A method is specified for identifying an interference effect. The hearing system includes a hearing device, which is worn by a user for sound output to the user. The hearing system is configured to recurrently receive a report from the user such that an interference effect is present in the sound output. If the user reports an interference effect in a present situation, multiple features of the present situation are ascertained and stored as a feature set. An identification unit compares multiple stored feature sets to one another and ascertains those features which correspond in the multiple feature sets and which are then assumed as characteristic features of the interference effect, so that the identification unit identifies the interference effect on the basis of the characteristic features.

### CROSS-REFERENCE TO RELATED APPLICATION

This application claims the priority, under 35 U.S.C. § 119, of German patent application DE 10 2020 209 048.3, filed Jul. 20, 2020; the prior application is herewith incorporated by reference in its entirety.

### BACKGROUND OF THE INVENTION

### Field of the Invention

The invention relates to a method for identifying an interference effect and a hearing system.

A hearing system includes a hearing device such as a hearing aid, which is worn by a user on or in the ear. In operation, the hearing device records noises from the surroundings by means of one or more microphones and generates electrical input signals, which are converted back into noises via a receiver of the hearing device and output to the user. The electrical input signals are processed by a signal processing unit to form electrical output signals for the receiver in order to adapt the hearing experience and the perception of the noises to the personal requirements of the user. A hearing device is typically used to care for a hearing-impaired user, i.e., to compensate for a hearing deficit of the user. The signal processing unit then processes the electrical input signals in such a way that the hearing deficit is compensated for.

In operation, diverse interference effects can occur at different points of the processing from the recording of the noises to the output to the user. Examples of interference effects are wind noises, whistling, i.e., feedback, artifacts, damping, reverberation, and the like. The identification by the user themselves is often difficult, particularly because the user typically does not have detailed knowledge of the mode of operation of the hearing device. A description of an interference effect by the user for the purpose of identification by a person skilled in the art or by means of a database is also typically difficult, since the user often lacks the terms for unambiguous and clear description of the interference effect.

### BRIEF SUMMARY OF THE INVENTION

Against this background, it is an object of the invention to improve the identification of an interference effect. For this purpose, an improved method and an improved hearing system are to be specified. The identification is to be as reliable and simple as possible.

The object is achieved according to the invention by a method having the features according to the independent method claim and by a hearing system having the features according to the independent hearing system claim and by a computer program product having the features according to the independent computer program product claim. Advantageous embodiments, refinements, and variants are the subject matter of the dependent claims. The object is furthermore independently achieved in particular respectively by a hearing device and by an auxiliary device, which are each configured to carry out the method. The statements in conjunction with the method also apply accordingly to the hearing system, the computer program product, the hearing device, and the auxiliary device and vice versa. If method steps of the method are described hereinafter, advantageous embodiments result for the hearing system, the hearing device, and the auxiliary system in particular in that these are configured to execute one or more of these method steps.

A core concept of the invention is in particular the identification of an interference effect in the sound output of a hearing device by means of simple reports by the user, without requiring a more precise description or characterization of the interference effect from them. Subjective descriptions or denotations of the interference effect by the user are advantageously omitted. In the identification, features of a situation are ascertained in which the user perceives an interference effect without the user having to describe the interference effect in detail. The measure which is possibly then taken in reaction to the interference effects, in contrast, is initially not important in the present case. However, a suitable measure can be selected particularly accurately and optimally by the identification of the interference effect.

The method is generally used for operating a hearing system and is especially a method for identifying an interference effect. An “interference effect” is understood in particular as a non-optimal or improper processing by the hearing system, which has an audible effect for the user. “Identification” is understood in particular to mean that it is recognized which interference effect it actually is, that the interference effect is thus somehow described or characterized or even explicitly named or denoted, in order to then react thereto with a suitable measure. The interference effect is generally an effect audible by the user upon the sound output, by which the sound output is perceived by the user as subjectively non-optimal, flawed, inadequate, incorrect, or otherwise deficient. Examples of interference effects are wind noises, comb filter effects, feedback effects, echoes, whistling, banging, clinking, speech noises, artifacts, reverberation, excessively high or low volume, excessively sharp or dull tone, and the like.

The hearing system includes a hearing device, which is worn by a user, for sound output to the user. The hearing device preferably includes at least one microphone, which records sound from the surroundings and generates an electrical input signal. This is supplied for modification to a signal processing unit of the hearing device. The signal processing unit is preferably a part of a control unit of the hearing device. The hearing device is preferably used to care for a hearing-impaired user. The modification is carried out for this purpose in particular on the basis of an individual audiogram of the user, which is associated with the hearing device, so that an individual hearing deficit of the user is compensated for. The signal processing outputs as a result an electrical output signal, which is then converted via a receiver of the hearing device back into sound and is output to the user. The hearing device is preferably a binaural hearing device, having two individual devices, which each include at least one microphone and one receiver and which are worn by the user on different sides of the head, namely once on or in the left ear and once on or in the right ear.

The hearing system is configured to recurrently receive a report from the user such that an interference effect is present in the sound output. The interference effect does not have to be known to the user, rather it is sufficient in the present case that solely the presence of an interference effect can be reported. A description, characterization, or the like of the interference effect is in particular not required from the user. To receive a report from the user, the hearing system expediently has an input element, e.g., a switch, a button, or a microphone for speech input. The input element is part of the hearing device or part of an auxiliary device of the hearing system. A suitable auxiliary device is in particular a mobile terminal, for example a smart phone. A report can be generated by actuating the input element. It is sufficient as already described that a report takes place at all, whereby the interference effect is solely indicated without further characterization.

If the user reports an interference effect in a present situation, multiple features of the present situation are ascertained by the hearing system and stored as a feature set. The present situation is the situation which exists at a given time. A situation is characterized in particular by features of the surroundings and/or of the hearing system. Such features are in particular parameters or properties of the surroundings or the hearing system. Examples of features of the surroundings are volume, strength of interference noises, presence of specific sound sources, e.g., speech, music, or noise. Features which relate to the user, for example his velocity, are also features of the surroundings. Examples of features of the hearing system are features of the hearing device, in general a setting of the hearing device, especially, for example, amplification in the signal processing unit, configuration of a filter or a compressor or another part of the signal processing unit.

As soon the hearing system receives a report, multiple features of the present situation are stored, in particular together with the information that an interference effect exists. The features form a feature set, of which it is known on the basis of the report that an interference effect exists for this feature set. The features describe the situation in particular in the chronological and/or spatial vicinity of the report, i.e., the features characterize the surroundings and/or the hearing system at the time of the report or in a time window of in particular at most 10 seconds, preferably at most 5 seconds or even less, around the time of the report. For example, features are acquired and temporarily stored continuously and are then permanently stored in the event of a report to obtain special features before the actual report, which are particularly informative, since they have presumably resulted in the report, while features after the report are typically, but not necessarily less relevant. “Spatial vicinity” is understood in particular to mean that the features characterize the hearing system itself and the surroundings in particular in hearing range of the user, more precisely in a range in which sound signals are still recorded by the hearing device. This range is typically strongly dependent on the sound source which emits a sound signal.

An identification unit now compares multiple stored feature sets to one another and ascertains those features which correspond in the multiple feature sets and which are then assumed as characteristic features of the interference effect, so that the identification unit identifies the interference effect on the basis of the characteristic features. Therefore, multiple reports of the user are evaluated and thus it is ascertained on the basis of recurring reports which features exist repeatedly and are thus characteristic for the interference effect, which is identified in this way. The characteristic features, preferably plus a tolerance range, thus already describe the interference effect, so that an identification of the interference effect is carried out by the identification unit, namely at least insofar as it is now described by the characteristic features. The feature sets are evaluated by the identification unit; how this takes place precisely is of subordinate significance, it is predominantly relevant that the characteristic features are ascertained. In this case, for example, those features of various feature sets are assumed to be similar which are within a predefined interval or differ from one another at most by a maximum value.

The characteristic features are particularly suitable in principle for identification of the interference effect and are therefore also used for this purpose. It is initially unimportant how precisely the characteristic features are formed, in particular since they are typically different for each interference effect, thus are dependent on the specific interference effect. In any case, it is more relevant that the characteristic features characterize the interference effect and are present reproducibly when the interference effect occurs, so that a causal relationship between the characteristic features and the interference effect is probable. In the context of the method, in particular multiple reports are accepted by the hearing system. Because the user repeatedly reports the interference effect, the characteristic features are ascertained more and more accurately with time, so that an identification of the interference effect is possible on the basis of the characteristic features and also becomes more and more accurate with further reports, without the user having to characterize the interference effect themselves in any way. The characteristic features more or less form a fingerprint of the interference effect, so that it is identifiable.

The identification unit is in particular a part of the hearing system. The identification unit is preferably a part of the hearing device or a part of an auxiliary device of the hearing system or is distributed thereon. A suitable auxiliary device is, for example, a mobile terminal, as already described above, or a server, which is connected via a network for data exchange to the hearing device and/or a mobile terminal of the hearing device.

One advantage of the invention is in particular that an interference effect is identified simply and reliably without more precise specifications by the user. As soon as an interference effect is identified, it is possible to react thereto using a corresponding countermeasure, so that overall the operation of the hearing system, especially the sound output of the hearing device, is improved and the acceptance by the user is increased. The measure is expediently selected on the basis of the ascertained characteristic features, which represent a good description of the interference effect in principle and thus make it identifiable or even identify it directly. In contrast to subjective descriptions or characterizations of an interference effect by the user, e.g., “too loud”, “hollow”, “dull”, “whistling”, or the like, the characteristic features represent an objective description of the interference effect which contributes to more reliable identification.

An ascertainment of the characteristic features for the purpose of identification of the interference effect is in particular carried out automatically by the identification unit. In one preferred embodiment, the identification unit determines the probability with which a respective one of multiple predefined, i.e., previously known interference effects exists, i.e., which interference effect underlies a respective report with which reliability. The probabilities for a single report then form a probability set. A respective probability set is also referred to as an error definition, since it specifies which interference effect presumably exists and thus defines this by the individual probabilities. Each report thus generates a data pair made up of a feature set and a probability set. These data pairs are collected in particular by the hearing system and the identification unit ascertains therefrom the most probable interference effect, so that it is identified. For example, in one suitable embodiment, upon each report, the probabilities are simply added to each previously known interference effect and then the interference effect is identified as the one of the previously known interference effects which has the highest probability. In another suitable embodiment, upon each report, a counter for those of the previously known interference effects which has the highest probability is simply increased, and then the interference effect is identified as the one of the previously known interference effects which has the highest counter. The interference effect is thus advantageously also reliably identified in the event of occasional incorrect information by the user or in the case of varying causes.

The identification unit is in particular a type of intelligent classifier for interference effects. The features are supplied to the identification unit in the form of a feature set, among them in particular the characteristic features as input parameters, and as the output parameter the identification unit outputs, for example, a probability for the presence of a previously known interference effect from one or multiple probabilities each for the presence of one of multiple previously known interference effects. An artificial intelligence is especially suitable as an identification unit, in particular having a neural network or having a cluster analysis unit, which uses, for example, a k means algorithm.

In a neural network, for example, multiple layers of nodes are connected via suitable weights in such a way that upon supply of a feature set as input parameters, a corresponding probability set is output as an output parameter, which contains a probability for each of multiple interference effects that it is present. The probabilities are then expediently further processed as described above by the identification unit to select one of the interference effects and thus identify it specifically. In a cluster analysis unit, the feature sets form a cluster or spatial region for each previously known interference effect, for example. Upon supply of a feature set as input parameters for the cluster analysis unit, it then outputs as the output parameter, for example, the distances of the feature set to the various clusters, thus effectively the probability with which the feature set is associated with one of the clusters and with which the corresponding interference effect is present. The further processing is preferably carried out by the identification unit similarly to the statements on the neural network.

The identification unit is preferably pre-trained using previously known associations of interference effects with characteristic features. This takes place beforehand by means of a pre-training which is not necessarily a part of the method described here. The associations are in particular training data, also referred to as basic data, which were generated beforehand to train the identification unit. For this purpose, a plurality of situations is expediently simulated in a controlled manner to generate diverse interference effects with known features in such controlled situations. Data pairs made up of feature sets and probability sets are thus ascertained and generated by experiments and used for training the identification unit. For example, diverse interference effects are provoked at the factory in a selection of standard situations by deliberate selection and/or setting of parameters of the surroundings and of the hearing system, thus by deliberate setting of specific features. These interference effects are preferably identified by technicians or in other ways and in any case correctly and defined as previously known interference effects. The standard situations are expediently varied to obtain new situations similar thereto for the pretraining and enhance the database for the training of the identification unit and obtain a large number of training data efficiently. The result, i.e., the respective provoked interference effect, is then also known in each case.

In one expedient embodiment, the identification unit is pre-trained using training data which contain, on the one hand, real and, on the other hand, artificial training data. The real training data are previously known associations of previously known features with interference effects. The real training data are generated, for example, by measurements and/or experiments in that the associated features are determined for a specific interference effect. The artificial training data are then generated starting from the real training data in that new features, which are associated with the same interference effect, are generated from the previously known features for a respective interference effect by modification within a tolerance range. In particular, no measurements and/or experiments are carried out for this purpose; rather, it is assumed that the features for an interference effect are not necessarily discrete, but rather can deviate within a tolerance range without the interference effect decisively changing. Therefore, a minor variation of the features for an interference effect is deliberately generated to generate the artificial training data in such a way that the interference effect does not substantially change or at least does not disappear, so that then new features are found for this interference effect. In this way, a feature space is more or less generated by the additional artificial training data, which is then associated with the interference effect.

In principle, it is possible that the identification of the interference effect is not possible or is not possible uniquely, i.e., does not have a unique result, but rather multiple interference effects come into consideration.

Therefore, the method is expediently passed through multiple times, preferably until a specific probability is achieved for one of multiple possible interference effects. Preferably, trivial errors due to too few reports are avoided in that a minimum number of reports is required for the interference effect. In a suitable embodiment, a measure against the interference effect first takes place to this end when a specific minimum number of reports is present for this interference effect. Suitable minimum numbers are, for example, 2 to 5 or 2 to 10, however, other minimum numbers can also be suitable in principle.

Alternatively or additionally, an identification is no longer performed and in any case no measures are taken if an excessively large number of reports is present and the interference effect is then, for example, no longer identifiable, because characteristic features can no longer be found or a unique identification is no longer possible in general. In one suitable embodiment, for this purpose the interference effect is only identified until a specific maximum number of reports for this interference effect is reached. In other words: the interference effect is not identified if a specific maximum number of reports is present for this interference effect. Suitable maximum numbers are, for example, 10 to 100, preferably 10 to 50, particularly preferably 15 to 35. However, other maximum numbers can also be suitable in principle. As soon as the maximum number is reached, a notification is expediently output to the user by the hearing system to make contact with technicians with respect to the supposed interference effect or the hearing system directly arranges such contact.

To differentiate various interference effects, a respective feature set is expediently categorized and associated with a group for this purpose, so that a group of feature sets is associated with each interference effect. Only the feature sets of an individual group are then compared to one another when ascertaining corresponding features. In this way, multiple different interference effects are advantageously identified. It is thus possible for the user to indicate different interference effects to the hearing system using a simple report. Different interference effects each form a category and are described by a group of feature sets which is a subset of all feature sets. The feature sets are categorized, i.e., a categorization of the feature sets takes place. The goal of the categorization is not yet the actual identification of the interference effects, rather solely grouping the feature sets into groups which each at least probably identify the same interference effect. The feature sets are preferably associated with different groups on the basis of their similarity to one another, so that similar feature sets are associated with the same group, since they probably characterize the same interference effect, and different feature sets are associated with different groups, since they probably characterize different interference effects.

The categorization is performed automatically by the hearing system or manually by the user. A combination is also advantageous.

In one advantageous embodiment, a respective feature set is automatically characterized in that it is compared to already stored feature sets and associated with the group which contains the feature set most similar thereto. The categorization is performed in this case by the hearing system itself on the basis of a similarity consideration of various feature sets. Similar feature sets are associated with the same group, whereas non-similar feature sets are associated with different groups. How the similarity is determined is of lesser importance. For example, a mean deviation of the features of two feature sets from one another is used as a measure of the similarity.

In a further advantageous embodiment, a respective feature set is categorized in that it is inquired of the user at the time of the report or later whether the associated interference effect has already been previously reported, and in that furthermore the respective feature set is associated with the group having the feature set most similar thereto, if the associated interference effect has already been reported, and otherwise with a new group. In this way, a manual categorization takes place without requiring further details on the interference effect from the user, because especially in the manual categorization it is important that a description or characterization of the interference effect is also not yet requested here from the user. Rather, solely a relative specification is provided, namely whether the interference effect has already previously occurred or occurs for the first time. The accuracy of the categorization may thus be significantly improved. An absolute specification, i.e., which interference effect is present in the opinion of the user or which properties the interference effect has according to the subjective perception of the user, in contrast, is advantageously omitted.

In one suitable embodiment, automatic and manual categorization are combined in such a way that the identification unit automatically categorizes the feature set and outputs the result to the user for confirmation or rejection. The identification unit accordingly recognizes automatically whether or not the interference effect has already occurred and has this result verified by the user.

A setting for the hearing device, which reduces the interference effect, and which is then automatically set or proposed to the user, is expediently ascertained as a measure against the interference effect on the basis of the characteristic features. Both variants each represent a measure to react to the interference effect, in particular to eliminate it or to preclude or prevent it in future. Since the interference effect is now identified on the basis of the characteristic features, a setting is then looked up, for example, in a corresponding database for this interference effect or calculated on the basis of a calculation rule.

The feature sets are preferably collected in a central database, for centralized evaluation and respective association with an interference effect. The feature sets of multiple hearing systems are expediently collected in the database and thus combined for joint evaluation. The database is connectable and/or connected, for example, via the Internet to diverse hearing systems. The above-described groups are preferably also depicted in the database, i.e., the result of a possible categorization is also stored in the database and utilized. The centralized evaluation is expediently carried out by technicians, for example, audiologists, who are presented the feature sets and the interference effects identified thereby, to specify a suitable setting to avoid them. Progressively improved measures for preventing interference effects are thus provided. The settings are preferably transmitted from the database to a respective hearing system or requested thereby to react accordingly upon identification of a specific interference effect.

At least one of the features is suitably an operating parameter of the hearing device in the present situation, more precisely a value of an operating parameter of the hearing device. The operating parameter is, for example, a volume, an amplification, a compression, a setting of a filter, a direction or width of a beamformer, or the like.

Alternatively or additionally, at least one of the features is suitably a surroundings parameter, more precisely a value of a surroundings parameter, which is measured by a sensor of the hearing system in the present situation. The sensor generates in particular a measured value, which is then used as a feature. The surroundings parameter is, for example, an interference noise volume, the presence of a specific type of noise, for example speech or music, a velocity at which the user moves themselves and thus also the hearing device, a direction of a sound source, a temperature, or the like. The sensor is, for example, a microphone, a directional microphone, an acceleration sensor, a movement sensor, a temperature sensor, a GPS sensor, or the like.

An exemplary application for the method is described hereinafter to illustrate its sequence. The identification unit is pre-trained using feature sets for an interference effect, which results due to wind at the hearing device in various surroundings; the interference effect is accordingly “wind noises”. The identification unit is a part of a server, to which a hearing device is connected via a smart phone. The server, the smart phone, and the hearing device form a hearing system here. Alternatively, the identification unit is not part of a server, but rather part of the hearing device or the smart phone. The user wears the hearing device, which is, for example, a binaural hearing device, in which each of the individual devices has two microphones, which in particular face in different directions or are arranged at different positions on the respective individual device. The user now rides a bicycle and notices an interference noise. The user actuates an input element on the hearing device or on the smart phone, for example a button, or performs a speech input, and in this way generates a report which is received by the hearing system. The hearing system optionally additionally prompts the user to specify whether or not the interference effect has previously already occurred, in order to possibly categorize it. For the most reliable possible identification of the interference effect, multiple reports of this interference effect are typically necessary. Upon the report, the hearing device ascertains diverse features of the situation, for example, operating and surroundings parameters, stores them as a feature set, and transmits this to the identification unit. In the present example, the features are a respective microphone level of the microphones, measurement data of a movement sensor, a presently set amplification of the signal processing unit of the hearing device, and a presently set operating program of the hearing device. The identification unit uses the features of the feature set as input parameters and determines the characteristic features by comparison to previously reported feature sets on the same interference effect. On the basis of the characteristic features, in conjunction with the pretraining of the identification unit, the interference effect is then identified thereby. On the basis of this, the hearing system ascertains a new setting for the hearing device to prevent the interference effect in future. The new setting is either calculated or retrieved from a database and transmitted via the smart phone to the hearing device. In the present example, the features, especially the measurement data of the movement sensor, indicate a rapid movement of the user; in contrast, the amplification is not in a critical range. The identification unit concludes therefrom that the interference effects are artifacts caused by wind, i.e., wind noises. This results from the pretraining of the identification unit. It is then set or proposed as a new setting to predominantly or exclusively use the microphone of the respective two microphones of an individual device which has fewer wind noises in comparison to the other microphone. The user can now test this new setting and accept or discard it. Alternatively, the new setting is set and used directly.

A hearing system according to the invention is designed to carry out a method as described above. The hearing system preferably includes a control unit for this purpose. In the control unit, the method is implemented in particular by a program or circuit or a combination thereof. For example, the control unit is designed for this purpose as a microprocessor or as an ASIC or as a combination thereof. The control unit is allocated to the hearing device and the auxiliary device or integrated completely into the hearing device or into the auxiliary device. The use of an auxiliary device is not necessary as such, rather in one possible embodiment the hearing system only includes one hearing device, which is then configured to carry out the method. In principle, the above-described method steps may be allocated substantially arbitrarily to the auxiliary device and the hearing device.

The computer program product according to the invention contains an executable program, which automatically executes the method as described above upon or after an installation on a hearing system as described above. The program is installed either on the hearing device or on the auxiliary device or both.

Other features which are considered as characteristic for the invention are set forth in the appended claims.

Although the invention is illustrated and described herein as embodied in a method for identifying an interference effect and a hearing system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

Exemplary embodiments of the invention are explained in greater detail hereinafter on the basis of a drawing.

### BRIEF DESCRIPTION OF THE SEVERAL VIEWS OF THE DRAWING

FIG. 1 is an illustration showing a hearing system according to the invention; and

FIG. 2 is a flow diagram for illustrating a method.

### DETAILED DESCRIPTION OF THE INVENTION

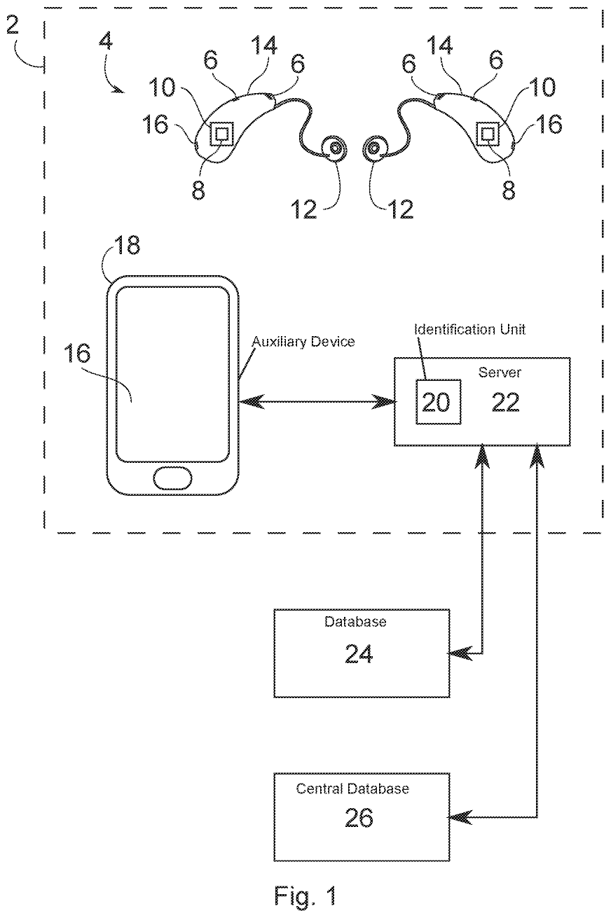

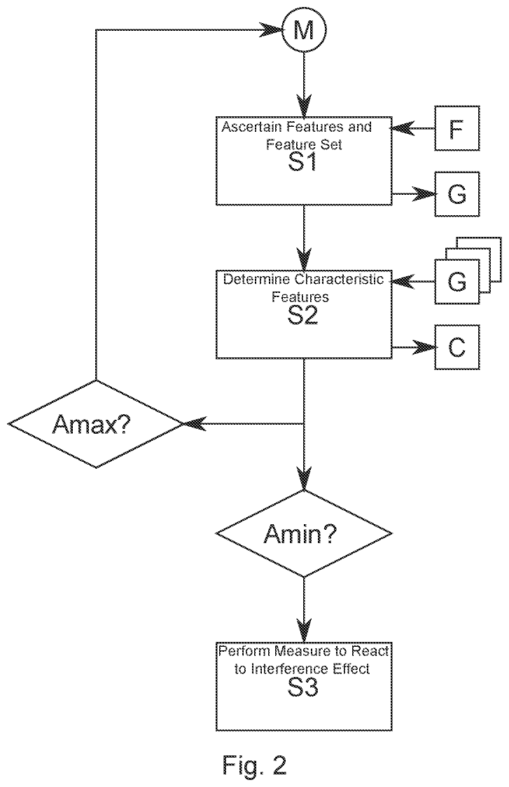

Referring now to the figures of the drawings in detail and first, particularly to FIG. 1 thereof, there is shown an exemplary embodiment of a hearing system 2 according to the invention. The hearing system 2 includes a hearing device 4, which is worn by a user (not explicitly shown) for sound output to the user. An interference effect possibly occurs during the sound output. A flow chart of an exemplary method for identifying the interference effect is shown in FIG. 2. A core concept here is that the interference effect is identified by a simple report M by the user, without requiring a more precise description or characterization of the interference effect from this user. In the identification, features F of a situation are ascertained in which the user perceives the interference effect, without the user having to describe the interference effect in detail.

The hearing device 4 shown includes at least one microphone 6, which records sound from the surroundings and generates an electrical input signal. This is supplied for modification to a signal processing unit 8 of the hearing device 4. The signal processing unit 8 is a part of a control unit 10 of the hearing device 4. The hearing device 4 shown is used to care for a hearing-impaired user. The modification is performed for this purpose on the basis of an individual audiogram of the user, which is associated with the hearing device 4, so that an individual hearing deficit of the user is compensated for. The signal processing unit 8 outputs as a result an electrical output signal, which is then converted back into sound via a receiver 12 of the hearing device 2 and is output to the user. The hearing device 4 shown is a binaural hearing device 4, having two individual devices 14, which each include at least one microphone 6 and one receiver 12 and which are worn by the user on different sides of the head, namely once on or in the left ear and once on or in the right ear.

The method is generally used for operating a hearing system 2, for example, as shown in FIG. 1, and is especially a method for identification of an interference effect. The interference effect is generally an effect audible to the user during the sound output by the hearing device 4. Due to the interference effect, this sound output is perceived by the user in a manner which is subjectively nonoptimal, faulty, inadequate, incorrect, or otherwise deficient.

The hearing system 2 is configured to recurrently receive a report M from the user such that an interference effect is present in the sound output. The interference effect does not have to be known to the user, rather it is sufficient in the present case that solely the presence of an interference effect can be reported. To receive a report M from the user, i.e., accept it, the hearing system 2 includes an input element 16 here, e.g., a switch, a button, or a microphone for speech input. As shown in FIG. 1, the input element 16 is, for example, a part of the hearing device 4 or a part of an auxiliary device 18 of the hearing system 2. The auxiliary device 18 shown as an example in FIG. 1 is a mobile terminal, especially a smart phone here. By actuating the input element 16, a report M can be generated, which is accepted by the hearing system 2 in a first step S1 of the method, as is recognizable in FIG. 2.

If the user reports an interference effect in a present situation, multiple features F of the present situation are ascertained by the hearing system 2 in first step S1 and stored as a feature set G. The present situation is the situation which exists at a given time and is characterized by features F of the surroundings and/or the hearing system 2. Such features F are, for example, parameters or properties of the surroundings or the hearing system 2.

As soon as the hearing system 2 receives a report M, multiple features F of the present situation are stored and form a feature set G, of which it is known on the basis of the report M that an interference effect exists for this feature set G. The features F describe the situation in the chronological and spatial vicinity of the report M, i.e., the features F characterize the surroundings and/or the hearing system 2 at the time of the report M or in a time window around the time of the report M and in hearing range of the user or within a space in which the user is located.

An identification unit 20 of the hearing system 2 now compares multiple stored feature sets G to one another and ascertains in a second step S2 of the method those features F which correspond in the multiple feature sets G and which are then assumed as characteristic features C of the interference effect, so that the identification unit 20 identifies the interference effect on the basis of the characteristic features C. Multiple reports M of the user are evaluated here, so that it is thus ascertained on the basis of recurring reports M which features F are present recurrently and are thus characteristic for the interference effect, which is identified in this way. In the context of the method, multiple reports M are accordingly typically accepted by the hearing system 2. The two steps S1 and S2 are repeated for each report M. Because the user recurrently reports the interference effect, the characteristic features C are ascertained more and more precisely with time, so that an identification of the interference effect on the basis of the characteristic features C is possible and also becomes more and more accurate with further reports M, without the user having to characterize the interference effect themselves in any way.

An ascertainment of the characteristic features C for the purpose of identification of the interference effect is carried out automatically by the identification unit 20. The identification unit 20 determines, for example, with which probability a respective one of multiple predefined, i.e., previously known interference effects is present, i.e., which interference effect underlies a respective report M with which probability. The probabilities for a single report M then form a probability set. A respective probability set is also referred to as an error definition, since it specifies which interference effect is probably present and thus defines it by way of the individual probabilities. Each report M thus generates a data pair made up of a feature set G and a probability set. These data pairs are collected by the hearing system 2 and the identification unit 20 ascertains therefrom, also in the second step S2, the most probable interference effect, so that it is identified. For example, upon each report M, the probabilities are simply added to each previously known interference effect and then the interference effect is identified as the one of the previously known interference effects which has the highest probability. In another suitable embodiment, upon each report, a counter for the one of the previously known interference effects is simply increased which has the highest probability and then the interference effect is identified as the one of the previously known interference effects which has the highest counter.

The identification unit 20 is a part of the hearing device 2 or a part of an auxiliary device 18 of the hearing system 2 or is distributed thereon. The auxiliary device 18 is, for example, the mobile terminal shown in FIG. 1 or, as explicitly shown here, a server 22, which is connected via a network for data exchange to the hearing device 4 and/or a mobile terminal of the hearing system 2, the auxiliary device 18 here.

The identification unit 20 is a type of intelligent classifier for interference effects. Features F are supplied as input parameters to the identification unit 20 and the identification unit 20 then outputs an interference effect as the output parameter. In the exemplary embodiment shown, the identification unit 20 is an artificial intelligence and includes for this purpose, for example, a neural network or a cluster analysis unit. The features F of a respective feature set G are then input parameters for the identification unit 20 and the identified interference effect is an output parameter of the identification unit 20. The identification unit 20 shown here is pretrained using previously known associations of interference effects with characteristic features C. This takes place beforehand by means of a pretraining, which is not necessarily a part of the method described here. The associations are, for example, training data, which were generated beforehand to train the identification unit 20.

It is fundamentally conceivable that the identification of the interference effect is not possible or is not uniquely possible, i.e., does not have a unique result, but rather multiple interference effects come into consideration. In the present case, the method is therefore run through multiple times, for example until a specific probability is reached for one of multiple possible interference effects. In the present case, a measure against the interference effect in step S3 only takes place when a specific minimum number Amin of reports M is present for this interference effect. In addition, in the present case the interference effect is only identified until a specific maximum number Amax of reports M is reached for this interference effect and then each further report M is ignored. Instead, the user is notified to contact a technician to identify and/or remedy the interference effect.

Optionally, to differentiate various interference effects, a respective feature set G is categorized and associated with a group for this purpose, so that a group of feature sets G is associated with each interference effect. Only the feature sets G of a single group are then compared to one another upon the ascertainment of corresponding features F. The method shown in FIG. 2 shows only one group and then is carried out more or less multiple times in parallel for multiple groups for each of multiple interference effects, so that multiple different interference effects can be identified. A categorization of the feature sets G takes place, with the goal of grouping the feature sets G into groups, which each at least probably characterize the same interference effect. The feature sets G are associated, for example, on the basis of their similarity to one another with various groups, so that similar feature sets G are associated with the same group, since they probably characterize the same interference effect, and different feature sets G are associated with different groups, since they probably characterize different interference effects.

The categorization is carried out automatically by the hearing system and/or manually by the user. For example, a respective feature set G is automatically characterized in that it is compared to already stored feature sets G and associated with the group which contains the most similar feature set G thereto. A manual categorization is performed, for example, in that it is inquired of the user at the time of the report M or later whether the associated interference effect has already previously been reported, and in that furthermore the respective feature set G is associated with the group having the most similar feature set G thereto, if the associated interference effect has already been previously reported, and otherwise with a new group.

On the basis of the characteristic features C, in the present case in step S3, a setting for the hearing device 4 is ascertained as a measure in reaction to the interference effect, which reduces the associated interference effect, and which is then also automatically set or proposed to the user in the present case in step S3. Since the interference effect is now identified on the basis of the characteristic features C, a setting is looked up in a corresponding database 24 for this interference effect or calculated on the basis of a computing rule, for example.

The feature sets G are collected in the present case in a central database 26, for centralized evaluation and respective association with an interference effect. In the present case, the feature sets G of multiple hearing systems 2 are collected in the database 26 and thus combined for joint evaluation. The settings are then transmitted from the database 26 to a respective hearing system 2 or requested thereby to react accordingly upon identification of a specific interference effect.

The following is a summary list of reference numerals and the corresponding structure used in the above description of the invention:
2 hearing system
4 hearing device
6 microphone
8 signal processing unit
10 control unit
12 receiver
14 individual device
16 input element
18 auxiliary device
20 identification unit
22 server
24 database
26 central database
Amax maximum number
Amin minimum number
C characteristic feature
F feature
G feature set
M report
S1 first step
S2 second step
S3 third step

1. A method for identifying an interference effect, which comprises the steps of:
providing a hearing system having a hearing device, the hearing device being worn by a user for outputting sound to the user, wherein the hearing system being configured to recurrently receive a report from the user when the interference effect is present in the sound output;
ascertaining and storing multiple features of a present situation as a feature set, if the user reports the interference effect in the present situation; and
comparing, via an identification unit, multiple stored feature sets to one another and ascertaining the features which correspond in the multiple feature sets and which are then assumed as characteristic features of the interference effect, so that the identification unit identifies the interference effect on a basis of the characteristic features.

2. The method according to claim 1, wherein the identification unit is pretrained using previously known associations of the interference effects with the characteristic features.

3. The method according to claim 1, wherein:
the identification unit is pretrained using training data, which contain real training data and artificial training data;
the real training data are previously known associations of previously known features with the interference effects; and
the artificial training data are generated starting from the real training data in that new features, which are associated with a same said interference effect, are generated from the previously known features for a respective interference effect by modification within a tolerance range.

4. The method according to claim 1, wherein a measure against the interference effect first takes place when a specific minimum number of reports for the interference effect exists.

5. The method according to claim 1, wherein the interference effect is only identified until a specific maximum number of reports is reached for the interference effect.

6. The method according to claim 1, wherein:
to differentiate various said interference effects, the feature set is categorized and associated with a group, so that a group of feature sets is associated with each said interference effect; and
during an ascertainment of corresponding features, only the feature sets of a single group are compared to one another.

7. The method according to claim 6, wherein a respective feature set of the features sets is automatically categorized in that it is compared to the stored feature sets and associated with the group which contains a most similar feature set thereto.

8. The method according to claim 5, wherein a respective feature set of the feature sets is categorized in that it is inquired of the user whether an associated interference effect has already previously been reported, and in that furthermore the respective feature set is associated with the group having a most similar feature set thereto, if the associated interference effect has already been previously reported, and otherwise with a new group.

9. The method according to claim 1, wherein a setting for the hearing device is ascertained on a basis of the characteristic features, which reduces the interference effect, and which is then set automatically or proposed to the user.

10. The method according to claim 1, wherein the feature sets are collected in a central database, for centralized evaluation and respective association with the interference effect.

11. The method according to claim 1, wherein at least one of the features is an operating parameter of the hearing device in the present situation.

12. The method according to claim 1, wherein at least one of the features is a surroundings parameter, which is measured using a sensor of the hearing system in the present situation.

13. A hearing system for identifying an interference effect, comprising:
a hearing device being worn by a user for outputting sound to the user, wherein the hearing system being configured to recurrently receive a report from the user when the interference effect is present in the sound output; and
an identification unit;
the hearing system programmed to:
ascertain and store multiple features of a present situation as a feature set if the user reports the interference effect in the present situation; and
compare, via said identification unit, multiple stored feature sets to one another and ascertaining the features which correspond in the multiple feature sets and which are then assumed as characteristic features of the interference effect, so that said identification unit identifies the interference effect on a basis of the characteristic features.

14. A non-transitory computer readable medium having computer executable instructions for automatically executing a method for identifying an interference effect after an installation of a hearing system having a hearing device, the hearing device being worn by a user for outputting sound to the user, wherein the hearing system being configured to recurrently receive a report from the user when an interference effect is present in the sound output, which comprises the steps of:
ascertaining and storing multiple features of a present situation as a feature set, if the user reports the interference effect in the present situation; and
comparing, via an identification unit, multiple stored feature sets to one another and ascertaining the features which correspond in the multiple feature sets and which are then assumed as characteristic features of the interference effect, so that the identification unit identifies the interference effect on a basis of the characteristic features.
